(19) United States
(12) Patent Application Publication
(10) Pub. No.: US 2012/0136879 A1
(43) Pub. Date: May 31, 2012

(54) SYSTEMS AND METHODS FOR FILTERING INTERPOLATED INPUT DATA BASED ON USER-SUPPLIED OR OTHER APPROXIMATION CONSTRAINTS

(76) Inventor: Eric Williamson, Willow Spring, NC (US)

(21) Appl. No.: 12/955,790

(22) Filed: Nov. 29, 2010

(51) Int. Cl. G06F 17/30

(52) U.S. Cl. 707/756; 707/E17.033

(57) ABSTRACT

Embodiments relate to systems and methods for filtering interpolated input data based on user-supplied or other approximation constraints. A database management system can store operational data, such as financial, medical, or other information. A user can access a set of target data, representing an output desired to be generated from an interpolated set of input data. Thus, the average air temperature of a region may be known for ten years, along with other inputs including water temperature, wind speed, and other data. The interpolation engine can receive a target temperature for the current year, and generate water temperatures, wind speeds, or other inputs that will produce the target temperature. The engine can also receive sets of approximation constraints supplied by a user, application, and/or other source to apply to the interpolated input values, and force those values to conform to an additional layer of desired criteria or constraints.

### FIELD

The invention relates generally to systems and methods for filtering interpolated input data based on user-supplied or other approximation constraints, and more particularly, to platforms and techniques for adapting interpolation operations to take the interpolated input results of a free-running interpolation engine, apply user-supplied or other approximation constraints, and develop further or additional interpolation results that fall within or satisfy that additional layer of constraints.

### BACKGROUND

In the fields of computational modeling and high performance computing, modeling platforms are known which contain a modeling engine to receive a variety of modeling inputs, and then generate a precise modeled output based on those inputs. In conventional modeling platforms, the set of inputs are precisely known, and the function applied to the modeling inputs is precisely known, but the ultimate results produced by the modeling engine are not known until the input data is supplied and the modeling engine is run. For example, in an econometric modeling platform, inputs for a particular industry like housing can be fed into a modeling engine. Those inputs can include, for instance, prevailing finance rates, employment rates, average new-home costs, costs of building materials, rate of inflation, and other economic or other variables that can be fed into the modeling engine which is programmed or configured to accept those inputs, apply a function or other processing to those inputs, and generate an output such as projected new-home sales for a given period of time. Those results can then be used to analyze or forecast other details related to the subject industry, such as predicted sector profits or employment.

In many real-life analytic applications, however, the necessary inputs for a given subject or study may not be known, while, at the same time, a desired or target output may be known or estimated with some accuracy. For instance, the research and development (R&D) department of a given corporation may be fixed at the beginning of a year or other budget cycle, but the assignment or allocation of that available amount of funds to different research teams or product areas may not be specified by managers or others. In such a case, an analyst may have to manually estimate and “back out” distributions of budget funds to different departments to begin to work out a set of component funding amounts that will, when combined, produce the already-known overall R&D or other budget. In performing that interpolation, the analyst may or may not be in possession of some departmental component budgets which have themselves also been fixed, or may or may not be in possession of the computation function which will appropriately sum or combine all component funds to produce the overall predetermined target budget. Adjustment of one component amount by hand may cause or suggest changes in other components in a ripple effect, which the analyst will then have to examine or account for in a further iteration of the same manual estimates.

In addition, in cases, after the interpolation results have been generated and presented to a user, it may be desirable or advantageous to permit the user the ability to take the set of interpolated inputs and/or other results, and apply a set of approximation constraints to those results, even if valid. That is, an operator may wish to apply or explore variants, subsets, and/or other adapted versions of the interpolation results based on their judgment, even to interpolation results which have been found to satisfy all conditions necessary to produce the desired target output. For example, while the interpolation platform may generate a set of valid financial budget inputs for the various departments of a large corporation, in an instance where managerial consideration is being given to reducing the size and budget of one department and folding other activities into another department, the analyst or other user or operator may wish to constrain the existing department budget to 50% of interpolated value, while wishing to examine the option of adding 10% of the other reduced half to one or a series of other departments that may absorb the remainder of the subject department's activities. In such a case, it may be of use to the operator to be able to apply percentage, range, or other constraints or extensions to the already-generated interpolated budgets of all departments whose budgets are being set.

In these and other scenarios, it may be desirable to provide systems and methods for filtering interpolated input data based on user-supplied or other approximation constraints, in which a user can operate an interpolation engine or platform, develop one or more sets of interpolated inputs and/or other generated results, and apply a set of approximation constraints to the interpolation results generated by the free-running platform to develop and calculate a set of constrained interpolated input data that satisfies an additional layer of user-supplied or other approximation or interpolation constraints.

### DESCRIPTION OF DRAWINGS

FIG. 1 illustrates an overall network architecture in which systems and methods for filtering interpolated input data based on user-supplied or other approximation constraints can be practiced, according to various embodiments of the present teachings;

FIGS. 2A-2C illustrate various exemplary sets of input data, and series of sets of input data, that can be used in or produced by systems and methods for filtering interpolated input data based on user-supplied or other approximation constraints, according to various embodiments;

FIG. 3 illustrates an exemplary operation of application constraints as applied to a set or subset of interpolated input data, according to aspects;

FIG. 4 illustrates an exemplary hardware configuration for client machine which can host or access systems and methods for filtering interpolated input data based on user-supplied or other approximation constraints, according to various embodiments; and

FIG. 5 illustrates a flowchart for overall interpolation, function determination, and other processing that can be used in systems and methods for filtering interpolated input data based on user-supplied or other approximation constraints, according to various embodiments; and

FIG. 6 illustrates a flowchart for the application of approximation constraints and/or other modifiers to interpolated input data that has been generated without modification, and other associated processing that can be used in systems and methods for filtering interpolated input data based on user-supplied or other approximation constraints, according to various embodiments.

### DESCRIPTION

Embodiments relate to systems and methods for filtering interpolated input data based on user-supplied or other approximation constraints. More particularly, embodiments relate to platforms and techniques for accessing a set of historical, operational, archival, or other operative data related to captured technical, financial, medical, or other operations, and supplying that operative data to an interpolation engine or platform. In addition, the interpolation engine can be supplied with or can access a set of target output data, for purposes of generating a set of estimated, approximated, inferred, or otherwise interpolated inputs that can be supplied to the interpolation engine to produce the target output. Thus, for instance, in an illustrative context of a climate modeling platform, a collection or set of historical input data, such as ocean temperatures, air temperatures, land temperatures, average wind speed and direction, average cloud cover, and/or other inputs or factors can be accessed or retrieved from a data store. The data store can for instance include records of those or other variables for each year of the last ten years, along with an output or result associated with those inputs, such as ocean level or polar cap area for each of those years or other series. In aspects, a partial set or subset of predetermined or fixed values for the same inputs can be supplied to the interpolation engine, such as predicted or assumed arctic temperatures, for the current year. The interpolation engine can also receive a set of target output data, such as the expected or projected ocean level or polar cap area for the current year. According to embodiments, the interpolation engine can then generate an interpolation function, and generate a set of interpolated inputs, such as air temperature, land temperature, average wind speed and direction, average cloud cover, and/or other remaining inputs whose values are unspecified, but which can be interpolated to produce values which when supplied as input to the interpolation engine can produce the set of target output data. In cases, the interpolation engine can generate different combinations of the set of interpolated input data in different generations or series, to permit an analyst or other user to manipulate the input values, to observe different ramifications of different component values for the set of interpolated inputs. The user can be presented with a selector dialog or other interface to manipulate the set of interpolated input values, and select or adjust those values and/or the interpolation function used to generate those values. The analyst or other user can thereby determine scenarios and potential inputs that will combine to realize the desired solution in the form of the set of target output data, and the values conformally producing that output can be varied or optimized. The ability to analyze and derive input sets that will produce already-know or fixed output can thereby be automated in whole or part, permitting a user to investigate a broader array of analytic scenarios more efficiently and effectively.

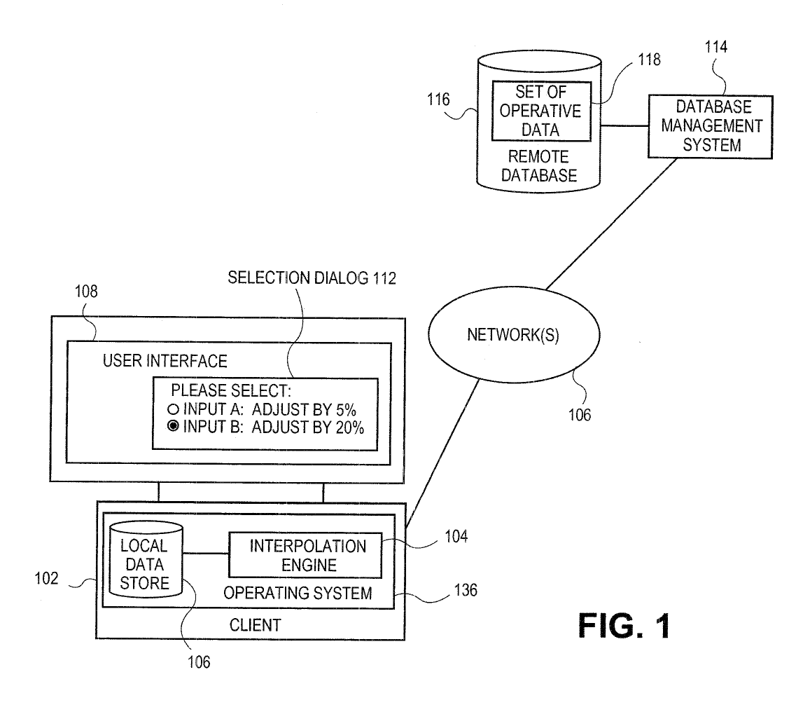

In embodiments as shown in FIG. 1, in accordance with embodiments of the invention, a user can operate a client 102 which is configured to host an interpolation engine 104, to perform interpolation and other analytic operations as described herein. In aspects, while embodiments are described in which interpolation engine 104 is described to operate on historical data to interpolate or fill in missing values or parameters, in embodiments, it will be understood that interpolation engine 104 can in addition or instead operate to produce extrapolated data, reflected expected future values of inputs and/or outputs. In aspects, the client 102 can be or include a personal computer such as a desktop or laptop computer, a network-enabled cellular telephone, a network-enabled media player, a personal digital assistant, and/or other machine, platform, computer, and/or device. In aspects, the client 102 can be or include a virtual machine, such as an instance of a virtual computer hosted in a cloud computing environment. In embodiments as shown, the client 102 can host or operate an operating system 136, and can host or access a local data store 106, such as a local hard disk, optical or solid state disk, and/or other storage. The client 102 can generate and present a user interface 108 to an analyst or other user of the client 102, which can be a graphical user interface hosted or presented by the operating system 136. In aspects, the interpolation engine 104 can generate a selection dialog 112 to the user via the user interface 108, to present the user with information and selections related to interpolation and other analytic operations.

In embodiments as likewise shown, the client 102 and/or interpolation engine 104 can communicate with a remote database management system 114 via one or more networks 106. The one or more networks 106 can be or include the Internet, and/or other public or private networks. The database management system 114 can host, access, and/or be associated with a remote database 116 which hosts a set of operative data 118. In aspects, the database management system 114 and/or remote database 118 can be or include remote database platforms such the commercially available Oracle™ database, an SQL (structured query language) database, an XML (extensible markup language) database, and/or other storage and data management platforms or services. In embodiments, the connection between client 102 and/or the interpolation engine 104 and the database management system 114 and associated remote database 116 can be a secure connection, such as an SSL (secure socket layer) connection, and/or other connection or channel. The interpolation engine 104 can access the set of operative data 118 via the database management system 114 and/or the remote database 116 to operate, analyze, interpolate and map the set of operative data 118 and other data sets to produce or conform to a set of target output data 120. In aspects, the predetermined or already-known set of target output data 120 can be stored in set of operative data 118, can be received as input from the user via selection dialog 112, and/or can be accessed or retrieved from other sources.

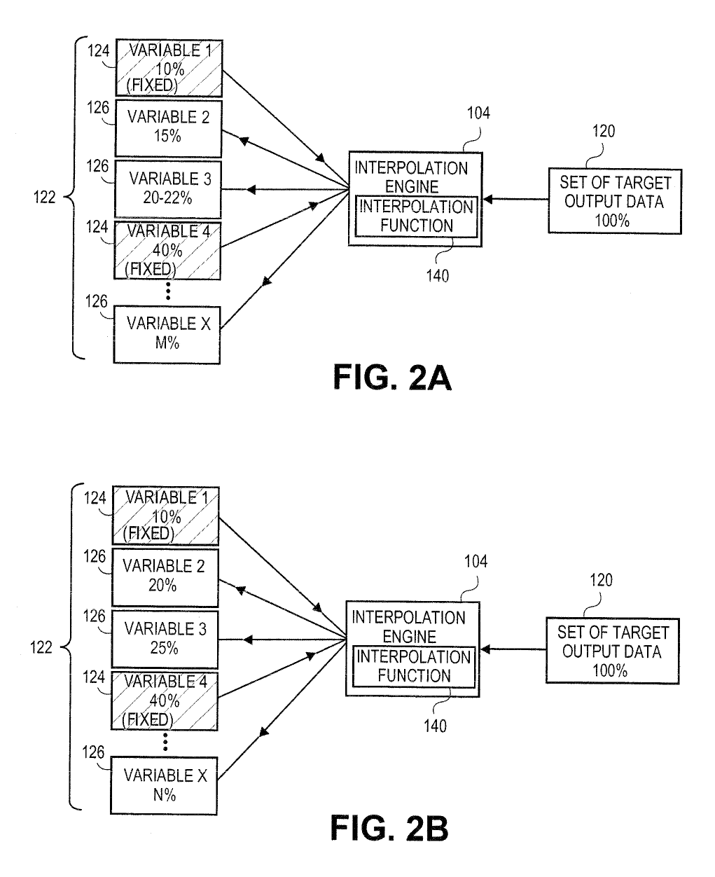

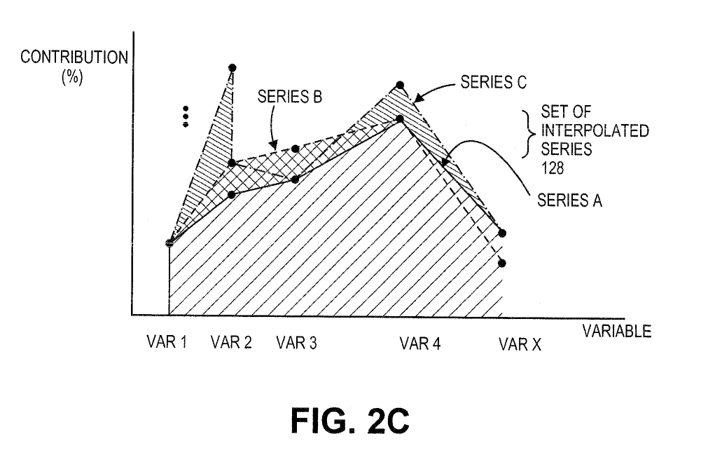

In embodiments, and as shown in FIGS. 2A-2C, the interpolation engine 104 can, in general, receive the set of target output data 120, and operate on that data to produce a conformal mapping of a set of combined input data 122 to generate an output of the desired set of target output data. As for instance shown in FIG. 2A, the set of combined input data 122 can, in cases, comprise at least two component input data sets or subsets. In aspects as shown, the set of combined input data 122 can comprise or contain a set of predetermined input data 124. The set of predetermined input data 124 can consist of data that is predetermined or already known or captured, for instance by accessing the set of operative data 118, and/or by receiving that data from the user as input via the selection dialog 112. In aspects, the set of predetermined input data 124 can include variables or other data which are already known to the user, to other parties, or has already been fixed or captured. In the case of a medical epidemiology study, for example, the set of predetermined input data 124 can include the number of vaccination doses available to treat an influenza or other infectious agent. For further example, in cases where the set of combined input data 122 represents the components of a corporate or government financial budget, the set of predetermined input data 124 can reflect the percentages (as for instance shown), for example to be allocated to different departments or agencies. It will be appreciated that other percentages, contributions, expressions, and/or scenarios or applications can be used.

In aspects, the interpolation engine 104 can access and process the set of predetermined input data 124 and the set of target output data 120, to generate a set of interpolated input data 126 which can produce the set of target output data 120 via an interpolation function 104. For instance, if the set of target output data 120 represents a total budget amount for an entity, then the set of interpolated input data 126 can reflect possible, approximate, or suggested values or percentages of that total funded amount that the interpolation engine 104 can allocate to various departments, using the interpolation function 140. Again, as noted the interpolation function 140 can be determined by interpolation engine 104 to generate the set of target output data 120, as predetermined by the user or otherwise known or fixed. In embodiments, interpolation techniques, functions, and/or other related processing as described in co-pending U.S. application Ser. No. 12/872,779, entitled “Systems and Methods for Interpolating Conformal Input Sets Based on a Target Output,” filed on Aug. 31, 2010, having the same inventor as this application, assigned or under obligation of assignment to the same entity as this application, and incorporated by reference in its entirety herein, can be used in determining interpolation function 140, configuring and/or executing interpolation engine 104, and/or performing other related operations.

The following applications, scenarios, applications, or illustrative studies will illustrate the interpolation action or activity that may be performed by the interpolation engine 104, according to various embodiments. In cases, again merely for illustration of exemplary interpolation analytics, the set of operative data 118 can be or include data related to medical studies or information. Thus for instance, the set of operative data 118 can include data for a set or group of years that relate to public health issues or events, such as the population-based course of the influenza seasons over that interval. The set of operative data can include variables or inputs that were captured or tracked for the influenza infection rate in the population for each year over the given window. Those variables or inputs can be or include, for instance, the percentage of the population receiving a public vaccine by Week 10 of the flu season, e.g. 20%, the age cohorts of the patients receiving the vaccine, the strain of the influenza virus upon which the vaccine is based, e.g. H5N5, the infectivity or transmission rate for a given infected individual, e.g. 3%, the average length of infectious illness for the infected population, e.g. 10 days, and/or other variables, metrics, data or inputs related to the epidemiology of the study. In aspects, the output or result of those tracked variables can be the overall infection rate for the total population at peak or at a given week or other time point, such as 40%. Other outputs or results can be selected. Those inputs and output(s) can be recorded in the set of operative data 118 for a set or group of years, such as for each year of 2000-2009, or other periods. In aspects, data so constituted can be accessed and analyzed, to generate interpolated data for current year 2010, although the comparable current inputs are not known or yet collected. In the current year (assumed to be 2010), one or more of the set of predetermined variables 124 may be known, such as, for instance, the vaccination rate of because yearly stocks are known or can be reliably projected, e.g. at 25%. In addition, an analyst or other user may specify a set of target output data 120 that can include the overall infection rate for the population the year under study, such as 35% at peak. In cases of this illustrative type, the interpolation engine 104 can access or receive the overall infection rate (35% peak) as the set of predetermined output data 120 or a part of that data, as well as the vaccination rate (25%) as the set of predetermined input data 124 or part of that data. In aspects, the interpolation engine 104 can access the collected historical data (for years 2000-2009) to analyze that data, and generate an interpolation function 140 which operates on the recorded inputs to produce the historical outputs (overall infection rate), for those prior years, either to exact precision, approximate precision, and/or to within specified margins or tolerance. The interpolation engine 104 can then access or receive the set of target output data 120 for the current (2010) year (35% peak infection), the set of predetermined input data (25% vaccination rate), and/or other variables or data, and utilize the interpolation function 140 to generate the set of interpolated input data 126. In the described scenario, the set of interpolated input data 126 generated or produced by the interpolation engine 104 can include the remaining unknown, speculative, uncollected, or otherwise unspecified inputs, such as the percentage of the population receiving a public vaccine by Week 10 of the flu season, e.g. 25%, the age cohorts of the patients receiving the vaccine, the strain of the influenza virus upon which the vaccine is based, e.g. H1N5, the infectivity or transmission rate for a given infected individual, e.g. 4%, the average length of infectious illness for the infected population, e.g. 9 days, and/or other variables, metrics, data or inputs. In aspects, the interpolation engine 104 can generate or decompose the set of interpolated input data 126 to produce the set of target output data 120 (here 35% peak infection) to exact or arbitrary precision, and/or to within a specified margin or tolerate, such as 1%. Other inputs, outputs, applications, data, ratios and functions can be used or analyzed using the systems and techniques of the present teachings.

In embodiments, as noted the interpolation function 140 can be generated by the interpolation engine 104 by examining the same or similar variables present in the set of operative data 118, for instance, medical data as described, or the total fiscal data for a government agency or corporation for a prior year or years. In such cases, the interpolation engine 104 can generate the interpolation function 140 by assigning the same or similar categories of variables a similar value as the average of prior years or sets of values for those same variables, and then perform an analytic process of those inputs to derive set of target output data 120 as currently presented. The interpolation engine 104 can, for example, apply a random perturbation analysis to the same variables from prior years, to produce deviations in amount for each input whose value is unknown and desired to be interpolated. When combinations of the set of predetermined input data 124 and set of interpolated input data 126 are found which produce the set of target output data 120, or an output within a selected margin of set of target output data 120, the user can operate the selection dialog 112112 or otherwise respond to accept or fix those recommended or generated values.

In cases, and as for instance illustrated in FIG. 2B, the set of combined input data 122 can be generated to produce the set of target output data 120 may not be unique, as different combinations of the set of predetermined input data 124 and set of interpolated input data 126 can be discovered to produce the set of target output data 120 either exactly, or to within specified tolerance. In such cases, different versions, generations, and/or series of set of combined input data 122 can be generated that will produce the set of target output data 120 to equal or approximately equal tolerance. For example, in cases where the set of operative data 118 relates to an epidemiological study, it may be found that a limit of 20 million cases of new infection during a flu season can be produced as the set of target output data 120 by applying 40 million doses of vaccine at week 6 of the influenza season, or can be produced as a limit by applying 70 million doses of vaccine at week 12 of the same influenza season. Other variables, operative data, ratios, balances, interpolated inputs, and outputs can be used or discovered. In embodiments as noted and as shown in FIG. 2C, when the possible conformal set of interpolated inputs 126 is not unique, the interpolation engine 104 can generate a set of interpolated series 128, each series containing a set of interpolated input data 126 which is different and contains potentially different interpolated inputs from other conformal data sets in the series of interpolated input sets 128. In cases where such alternatives exist, the interpolation engine 104 can generate and present the series of interpolated input sets 128, for instance, in series-by-series graphical representations or otherwise, to select, compare, and/or manipulate the results and values of those respective data sets. In embodiments, the analyst or other user may be given a selection or opportunity to choose one set of interpolated input data 126 out of the series of interpolated input sets 128 for use in their intended application, or can, in embodiments, be presented with options to continue to analyze and interpolate the set of operative data 118, for example to generate new series in the series of interpolated input sets 128. Other processing options, stages, and outcome selections are possible.

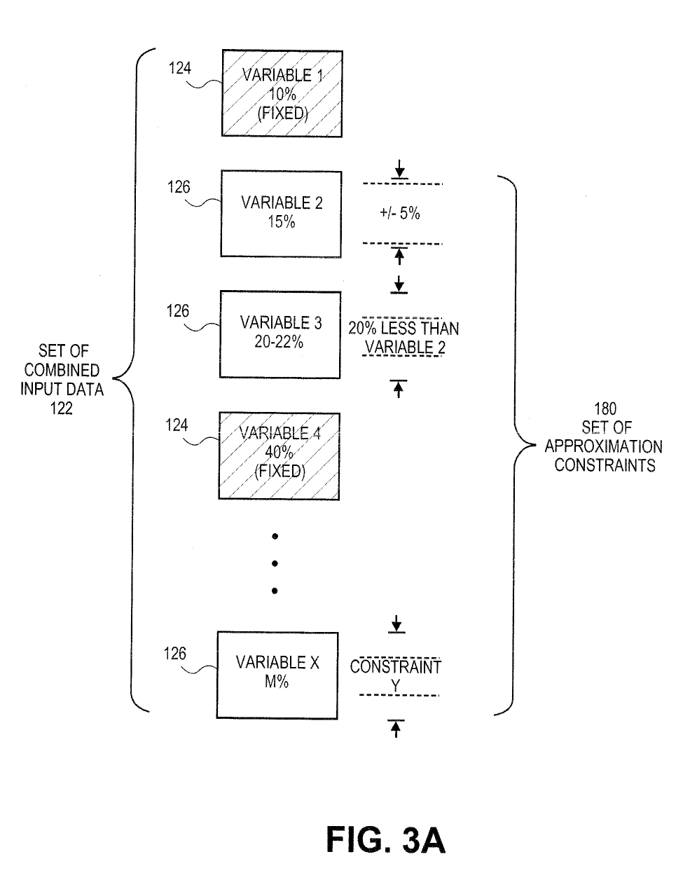

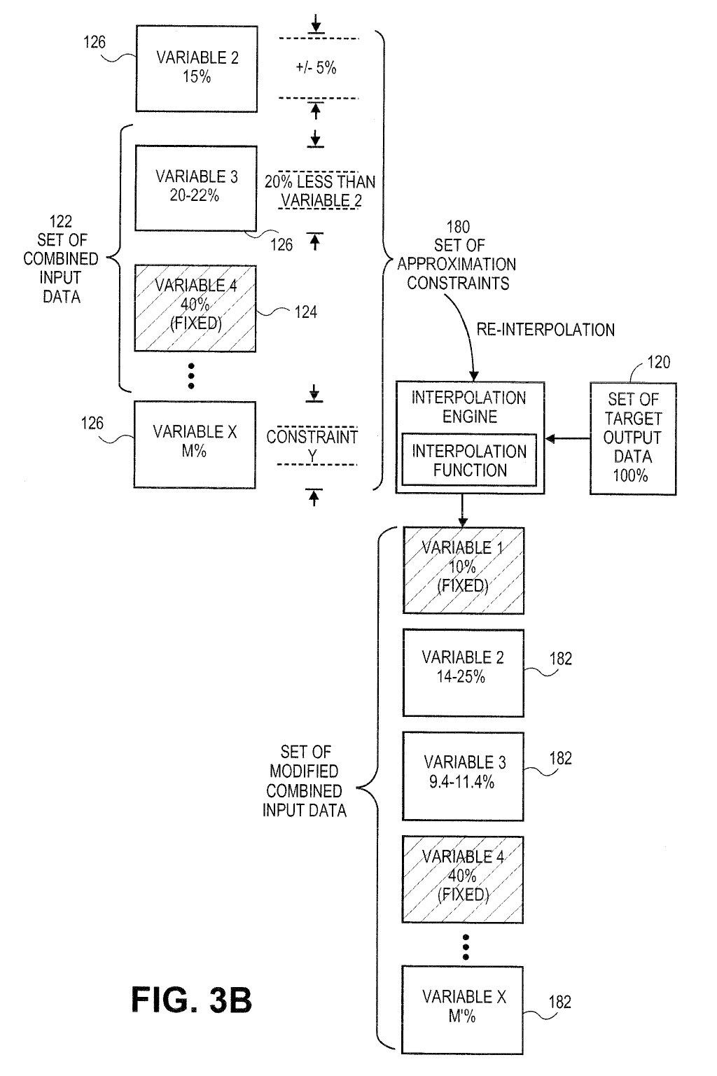

In aspects, and as for example illustrated in FIG. 3A, the interpolation engine 104 and/or other logic can be configured to receive, apply, and process various interpolation constraints or other modifications or factors that can be used to refine or adjust the set of interpolated input data 126, the interpolation function 140 itself, and/or other data or functions produced or operated upon by the interpolation engine 104. In aspects as shown, the interpolation engine 104 and/or other logic can apply a set of approximation constraints 180 to the set of interpolated input data 126, for instance after that data has been produced by an initial run of interpolation processing. In aspects as shown, the set of approximation constraints 180 can be configured as a set or series of constraints, limits, functions, boundaries, and/or other conditions, filters, and/or criteria to be applied to the set of interpolated input data 126, and/or other data. In aspects as shown, individual constraints can be applied to individual variables or parameters in the set of interpolated input data 126, in one-to-one fashion, but it will be understood that in embodiments, more than one constraint, limit, functions, boundary, and/or other conditions, filters, and/or criteria can be applied to one or more of the variables, parameters, or data constituting the set of interpolated input data 126.

In aspects, the set of approximation constraints 180 can consist of one or more constraint, limit, functions, boundary, and/or other conditions, filters, and/or criteria that can be of one or more types. In aspects as shown, the set of approximation constraints 180 can include upper and/or lower limits or boundaries on the value of individual variables in the set of interpolated input data 126, such as to indicate that Variable 2 shall be limited to a limit of 5% below the highest value initially calculated and/or 5% above the value lowest value initially calculated for that variable, to in effect “squeeze” or compress the possible values of that variable upon re-interpolation. In aspects as also shown, any one or more constraints in the set of approximation constraints 180 applied to one variable can be expressed or encoded as a function of another variable in the set of interpolated input data 126, such as to indicate that Variable 3 shall be limited to a value of 20% less than the value of Variable 2, as for example identified after re-interpolation has been carried out, although a function of that type can also be defined on variables or other data before re-interpolation has taken place. The set of approximation constraints 180 can likewise or instead apply a function of other data or variables, such as the set of target output data 120 and/or other variables, parameters, or data. Other constraints can be used, including for example statistical constraints. A statistical constraint could stipulate or limit, for example, the value of Variable 22 to be within two standard deviations of the average of Variables 15, 16, 17, and 18. Logical constraints can also be used, such as for example to indicate that a given variable must take on a “true” or other Boolean value. Constraints can likewise be made to be a function of, or otherwise associated with, multiple variables at one time. In aspects, the set of approximation constraints 180 can be received through user inputs or selections, for instance, via selector dialog 112 and/or other channel or interface. In aspects, the set of approximation constraints 180 or any portion thereof can be received from automated sources, such as an application and/or other program, software, or service.

In aspects, and as shown in FIG. 3B, after the interpolation engine 104 and/or other logic or service has received the set of approximation constraints 180 and any related data, the interpolation engine 104 can use those constraints to carry out further or additional interpolation operations, in this instance applying those constraints, limits, functions, boundary, and/or other conditions, filters, and/or criteria to any previously-interpolated set of interpolated input data 126, and/or other data to generate a modified combined input data 188, which set can include a set of constrained interpolated input data 182 reflecting the new and/or re-interpolated values of input variables after limiting, constraining, or conforming those values to the conditions reflected in the set of approximation constraints 180. After applying one set of set of approximation constraints 180, a user can, in aspects, enter a further and/or modified set of approximation constraints 180 to determine the effects of different constraints, possibly on different variables, to produce a sequence or series of the set of constrained interpolated input data 182, in the manner of aspects for example illustrated in FIG. 2C above. Other re-interpolation and/or constraint operations can be performed. For instance, the user can supply a set of approximation constraints 180 to be applied to two different sets of combined input data 122, for example, the financial results and associated accounting breakdowns for two different divisions of a company or other organization, or the epidemiological record for two difference influenza seasons, and generate two sets of constrained interpolated input data 182, in parallel fashion. Other operations, calculations, and reports can be generated or carried out.

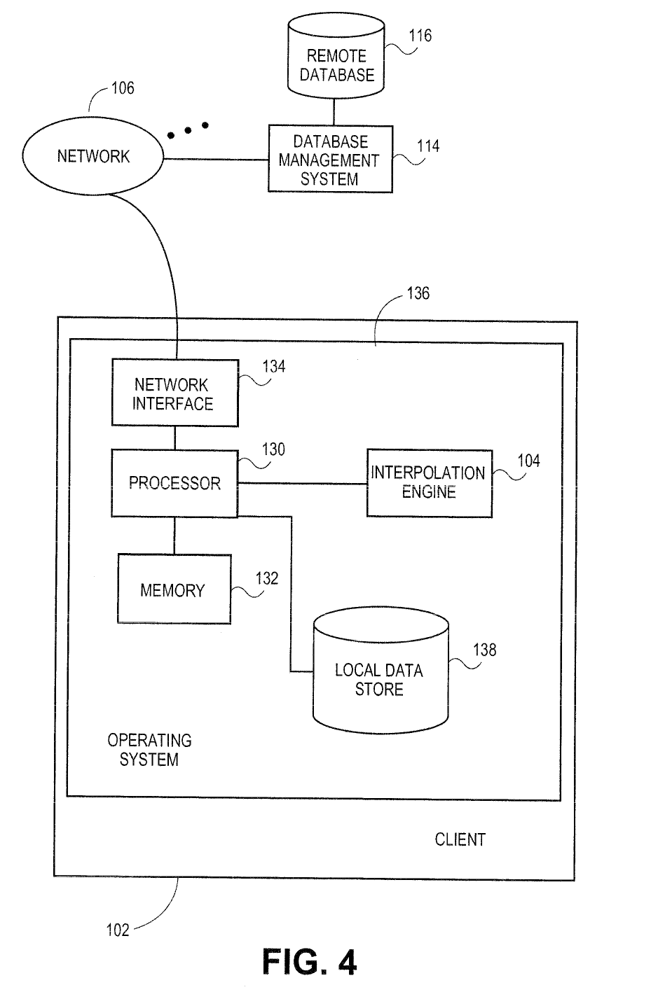

FIG. 4 illustrates an exemplary diagram of hardware and other resources that can be incorporated in a client 102 that can host or be used in connection with systems and methods for interpolating conformal input sets based on a target output, according to embodiments. In aspects, the client 102 can be or include a personal computer, a network enabled cellular telephone, or other networked computer, machine, or device. In embodiments as shown, the client 102 can comprise a processor 130 communicating with memory 132, such as electronic random access memory, operating under control of or in conjunction with operating system 136. Operating system 136 can be, for example, a distribution of the Linux™ operating system, the Unix™ operating system, or other open-source or proprietary operating system or platform. Processor 130 can also communicate with the interpolation engine 104 and/or a local data store 138, such as a database stored on a local hard drive. Processor 130 further communicates with network interface 134, such as an Ethernet or wireless data connection, which in turn communicates with one or more networks 106, such as the Internet or other public or private networks. Processor 130 also communicates with database management system 114 and/or remote database 116, such as an Oracle™ or other database system or platform, to access set of operative data 118 and/or other data stores or information. Other configurations of client 102, associated network connections, storage, and other hardware and software resources are possible. In aspects, the database management system 114 and/or other platforms can be or include a computer system comprising the same or similar components as the client 102, or can comprise different hardware and software resources.

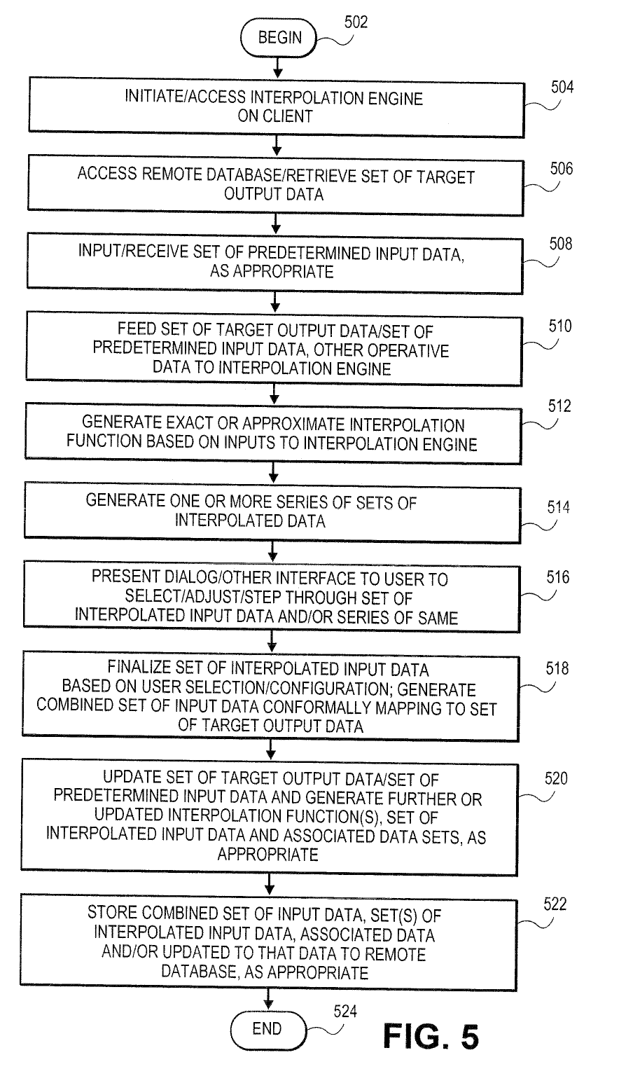

FIG. 5 illustrates a flowchart of overall processing to generate interpolation functions, sets of interpolated data, and other reports or information, according to various embodiments of the present teachings. In 502, processing can begin. In 504, a user can initiate and/or access the interpolation engine 104 on client 102, and/or through other devices, hardware, or services. In 506, the user can access the remote database 116 via the database management system 114 and retrieve the set of target output data 120 and/or other associated data or information. In 508, the interpolation engine 104 can input or receive the set of predetermined input data 124, as appropriate. In embodiments, the set of predetermined input data 124 can be received via a selection dialog 112 from the user or operator of client 102. In embodiments, the set of predetermined input data 124 can in addition or instead be retrieved from the set of operative data 116 stored in remote database 116, and/or other local or remote storage or sources. In aspects, the set of predetermined input data 124 can be or include data that is already known or predetermined, which has a precise target value, or whose value is otherwise fixed. For instance, in cases where the set of operative data 118 relates to an undersea oil reserve in a hydrology study, the total volume of oil stored in a reservoir can be known or fixed, and supplied as part of the set of predetermined input data 124 by the user or by retrieval from a local or remote database. In 510, the set of target output data 120, the set of predetermined input data 124, and/or other data in set of operative data 118 or other associated data can be fed to interpolation engine 104.

In 512, the interpolation engine 104 can generate the interpolation function 140 as an exact or approximate function that will generate output conforming to the set of target output data 120, as an output. In aspects, the interpolation function 140 can be generated using techniques such as, for instance, perturbation analysis, curve fitting analysis, other statistical analysis, linear programming, and/or other analytic techniques. In aspects, the interpolation function 140 can be generated to produce an approximation to the set of target output data 120, or can be generated to generate an approximation to set of target output data 120 to within an arbitrary or specified tolerance. The interpolation function 140 can also, in aspects, be generated to produce set of target output data 120 with the highest degree of available accuracy. In 514, the interpolation engine 104 can generate one or more subsets of interpolated input data 126, and/or one or more set of interpolated series 128 containing individual different combinations of subsets of interpolated input data 126. In aspects, the set of interpolated input data 126 and/or series of interpolated input sets 128 can be generated by applying the set of target output data 120 to the set of predetermined input data 124 and filling in values in the set of interpolated input data 126 which produce an output which conforms to the set of target output data 120, exactly or to within a specified tolerance range. In aspects, the set of interpolated input data 126 and/or series of interpolated input sets 128 can be generated by producing sets of possible interpolated inputs which are then presented to the user via the selection dialog 112, for instance to permit the user to accept, decline, or modify the values of set of interpolated input data 126 and/or series of interpolated input sets 128.

In 516, the interpolation engine 104 can present the selection dialog 112 to the user to select, adjust, step through, and/or otherwise manipulate the set of interpolated input data 126 and/or series of interpolated input sets 128, for instance to allow the user to view the effects or changing different interpolated input values in those data sets. For example, in a case where the set of operative data 118 relates to financial budgets for a corporation, the user may be permitted to manipulate the selection dialog 112 to reduce the funded budget amount for one department, resulting in or allowing an increase in the budget amounts for a second department or to permit greater investment in IT (information technology) upgrades in a third department. In aspects, the selection dialog 112 can permit the adjustment of the set of interpolated input data 126 and/or series of interpolated input sets 128 through different interface mechanisms, such as slider tools to slide the value of different interpolated inputs through desired ranges. In 518, the user can finalize the set of interpolated input data 126, and the interpolation engine 104 can generate the resulting combined set of input data 122 which conformally maps to the set of target output data 120. In 520, the set of target output data 120, set of predetermined input data 124, and/or other information related to the set of operational data 116 and the analytic systems or phenomena being analyzed can be updated. The interpolation engine 104 and/or other logic can generate a further or updated interpolation function 140, a further or updated set of interpolated input data 126, and/or an update to other associated data sets in response to any such update to the set of target output data 120 and/or set of predetermined input data 124, as appropriate. In 522, the combined set of input data 122, the set of interpolated input data 126, the series of interpolated input sets 128, the interpolation function 140, and/or associated data or information can be stored to the set of operative data 118 in the remote database 116, and/or to other local or remote storage. In 524, as understood by persons skilled in the art, processing can repeat, return to a prior processing point, jump to a further processing point, or end.

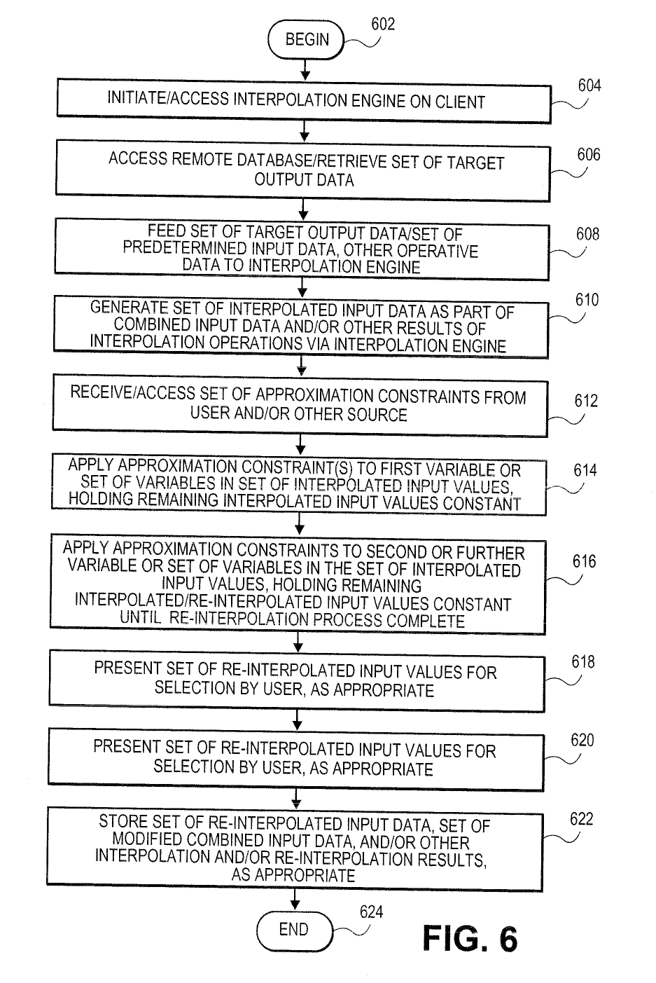

According to aspects, the interpolation operations performed by the interpolation engine 104 and/or other logic can be extended to apply user-supplied and/or automatically generated constraints to the set of interpolated input data 126 and/or other data operated on by the interpolation engine 104. FIG. 6 illustrates a flowchart of processing that can be used to generate, process, and apply a set of user-supplied approximation constraints 180 to the set of interpolated input data 126 and/or other variables, parameters, and/or data, according to various embodiments. In 602, processing can begin. In 604, the user can initiate and/or access the interpolation engine 104 and/or other logic or service, for instance via client 102. In 606, a user can access the remote database 116 and access or retrieve the set of target output data 120 and/or other files or data. In 608, the set of target output data 120, the set of predetermined input data 124 (or subsets of that data), and/or other operative data from set of operative data 118 can be received by the interpolation engine 104 and/or other logic or service.

In 610, the interpolation engine 104 and/or other logic or service can generate a set of interpolated input data 126 as part of the set of combined input data 122 and/or other results of interpolation operations via the interpolation engine 104. In 612, the interpolation engine 104 and/or other logic or service can receive the set of approximation constraints 180, through user input or selection, and/or via other source(s). For instance, in embodiments, the set of approximation constraints 180 and/or portions thereof can be received from an application, Web site, and/or local or remote service. In aspects, for instance, a statistical application or module can generate part or all of the set of approximation constraints 180, for user by the interpolation engine 104 and/or other logic in conforming the set of interpolated input data 126 and/or other interpolation results. In 614, the interpolation engine 104 and/or other logic or service can apply the set of approximation constraints 180 to the first variable, sets of variables, values, parameters, and/or other data contained in the set of interpolated input data 126 that has been previously generated by the interpolation engine 104 and/or other logic, for instance holding the other or remainder of the set of interpolated input data 126 fixed on a temporary basis. In 616, the interpolation engine 104 and/or other logic or service can apply the set of approximation constraints 180 to a second variable, sets of variables, values, parameters, and/or other data contained in the set of interpolated input data 126 that has been previously generated by the interpolation engine 104 and/or other logic, holding the other or remainder of the interpolated or re-interpolated set of interpolated input data 126 fixed, and repeating until the set of approximation constraints 180 have all been applied and re-interpolation action is complete. It may be noted, that re-interpolation or related operations can be repeated as many times as desired, for instance, by operating on different input data using the same set of approximation constraints 180, by operating on the same input data using different sets of approximation constraints 180, and/or otherwise. In 618, after all values of the set of constrained interpolated input data 182 have been computed, the set of constrained interpolated input data 182 can be presented to the user for acceptance or selection, as appropriate. In 620, interpolation engine 104 and/or other logic or service can accept and/or receive a further or updated set of approximation constraints 180 and/or repeat re-interpolation operations as described herein based on those new or updated constraints, as appropriate. In 622, the interpolation engine 104 and/or other logic or service can store the set of constrained interpolation input data 182, the set of modified combined input data 188, and/or other interpolation, re-interpolation, or associated results or outputs, as appropriate. For instance, the set of modified combined input data 188, including the set of constrained interpolated input data 182, and/or other data, can be stored to remote database 116 and/or other location or site. In 624, as understood by persons skilled in the art, processing can repeat, return to a prior processing point, jump to a further processing point, or end.

The foregoing description is illustrative, and variations in configuration and implementation may occur to persons skilled in the art. For example, while embodiments have been described in which the interpolation engine 104 comprises a single application or set of hosted logic in one client 102, in embodiments the interpolation and associated logic can be distributed among multiple local or remote clients or systems. In embodiments, multiple interpolation engines can be used. Similarly, while embodiments have been described in which the set of operative data 118 is accessed via one remote database management system 114 and/or a remote database 116 associated with the remote database management system 114, in embodiments, the set of operative data 118 and associated information can be stored in one or multiple other data stores or resources, including in local data store 138 of client 102. Other resources described as singular or integrated can in embodiments be plural or distributed, and resources described as multiple or distributed can in embodiments be combined. The scope of the invention is accordingly intended to be limited only by the following claims.

What is claimed:

1. A method of processing a set of interpolated input data, comprising:
accessing a set of combined input data, the set of combined input data comprising a set of predetermined input data and the set of interpolated input data, the set of interpolated data being generated to conformally map the set of combined input data to a set of target output data;
receiving a set of approximation constraints, the approximation constraints constraining a range of the set of interpolated input data; and
re-interpolating the set of interpolated input data based on the set of predetermined input data, the set of target output data, and the set of approximation constraints to generate a set of constrained interpolated input data as interpolation results.

2. The method of claim 1, wherein the set of approximation constraints comprises upper and lower boundaries on the set of interpolated input data.

3. The method of claim 1, wherein the upper and lower boundaries are generated by analyzing variance information in the set of interpolated input data, and the upper and lower boundaries are defined as a function of the variance information.

4. The method of claim 1, wherein receiving the set of approximation constraints comprises receiving a user input of the set of approximation constraints.

5. The method of claim 1, wherein receiving the set of approximation constraints comprises receiving a set of automatically generated approximation constraints from at least one of an application or service.

6. The method of claim 1, wherein the set of constrained interpolated input data conformally map the combined input data to the set of target output data.

7. The method of claim 1, wherein the set of interpolated input data comprises a set of interpolated input variables.

8. The method of claim 7, wherein the re-interpolating comprises applying the set of approximation constraints to successive subsets of the set of interpolated input variables while holding remaining interpolated input variables fixed to determine whether the combined input data conformally maps to the set of target output data.

9. The method of claim 1, wherein at least one constraint in the set of approximation constraints is a function of at least another constraint in the set of approximation constraints.

10. The method of claim 1, wherein the set of combined input data comprises at least one of a set of financial data, a set of medical data, a set of demographic data, a set of engineering data, a set of network operations data, or a set of geographic data.

11. The method of claim 1, further comprising generating a dialog to present a user with the set of constrained interpolated input data for acceptance or selection as the interpolation results.

12. A system for processing a set of interpolated input data, comprising:
an interface to a database storing a set of combined input data, the set of combined input data comprising a set of predetermined input data and the set of interpolated input data, the set of interpolated data being generated to conformally map the set of combined input data to a set of target output data; and
a processor, communicating with the database, the processor being configured to—
receive a set of approximation constraints, the approximation constraints constraining a range of the set of interpolated input data, and
re-interpolate the set of interpolated input data based on the set of predetermined input data, the set of target output data, and the set of approximation constraints to generate a set of constrained interpolated input data as interpolation results.

13. The system of claim 13, wherein the set of approximation constraints comprises upper and lower boundaries on the set of interpolated input data.

14. The system of claim 13, wherein the upper and lower boundaries are generated by analyzing variance information in the set of interpolated input data, and the upper and lower boundaries are defined as a function of the variance information.

15. The system of claim 13, wherein receiving the set of approximation constraints comprises receiving a user input of the set of approximation constraints.

16. The system of claim 13, wherein receiving the set of approximation constraints comprises receiving a set of automatically generated approximation constraints from at least one of an application or service.

17. The system of claim 1, wherein the set of constrained interpolated input data conformally map the combined input data to the set of target output data.

18. The system of claim 13, wherein the set of interpolated input data comprises a set of interpolated input variables.

19. The system of claim 18, wherein the re-interpolating comprises applying the set of approximation constraints to successive subsets of the set of interpolated input variables while holding remaining interpolated input variables fixed to determine whether the combined input data conformally maps to the set of target output data.

20. The system of claim 13, wherein at least one constraint in the set of approximation constraints is a function of at least another constraint in the set of approximation constraints.

21. The system of claim 13, wherein the set of combined input data comprises at least one of a set of financial data, a set of medical data, a set of demographic data, a set of engineering data, a set of network operations data, or a set of geographic data.

22. The system of claim 13, wherein the processor is further configured to generate a dialog to present a user with the set of constrained interpolated input data for acceptance or selection as the interpolation results.
